(19) United States
(12) Patent Application Publication
(10) Pub. No.: US 2018/0274734 A1
(43) Pub. Date: Sep. 27, 2018

(54) SNAP-IN LED BOARD RAIL SYSTEM FOR RETROFITTING FLUORESCENT LIGHT FIXTURES

(71) Applicant: ENERGY PLANNING ASSOCIATES CORP., Sanford, FL (US)

(72) Inventors: Dominick CERCE, Sanford, FL (US); Saturnino Oquendo, JR., Orlando, FL (US)

(21) Appl. No.: 15/468,601

(22) Filed: Mar. 24, 2017

(51) Int. Cl. F21K 9/272; F21V 3/02; F21V 17/16; F21K 9/278; F21V 23/00

(52) U.S. Cl. CPC F21K 9/272; F21V 3/02; F21Y 2115/10; F21K 9/278; F21V 23/005; F21V 17/16

(57) ABSTRACT

An LED board rail for retrofitting a fluorescent light fixture includes an LED board having a plurality of LEDs, and an elongated optical cover housing the LED board along its length, where the elongated optical cover has a first end and an opposing second end. The LED board rails also includes a first spring clip having a first finger and an opposing second finger, and a second spring clip having a first finger and an opposing second finger. The first and second spring clips are configured to engage respective first and second slots formed into a ballast cover of the existing fluorescent light fixture for first and second lamp holders.

### TECHNICAL FIELD

The present invention relates to the field of light fixtures, and, more particularly, to a snap-in LED board rail system for retrofitting existing fluorescent light fixtures and related methods.

### BACKGROUND

The fluorescent light bulbs are used in many commercial applications, particularly for indoor office lighting. The fluorescent light fixtures include a troffer with one or more fluorescent light bulbs, where the fluorescent light bulbs have different sizes. For example, common fluorescent lights for use in indoor lighting include the T5 (⅝ inch diameter), T8 (1 inch diameter), and the T12 (1½ inch diameter). Such fluorescent bulbs are relatively inefficient and have a relatively short life. Thus, efforts have been made to identify suitable alternative illumination sources for indoor office lighting applications. Light emitting diodes (“LEDs”) have been identified as one alternative to traditional fluorescent bulbs.

An LED typically includes a diode mounted onto a die or chip. The die is connected to a power source, which, in turn, transmits power to the diode. An LED used for lighting or illumination converts electrical energy to light in a manner that results in little radiant energy outside the visible spectrum.

Efforts have also been made to retrofit fluorescent light fixtures with an LED light fixtures. However, the heat generated by the LED light fixtures may cause problems related to the functions of the LEDs and light fixtures. In particular, the relatively high operating temperatures may degrade the performance of the LED light. For example, typical LED lights have a lifetime of approximately 50,000 hours at room temperature, but can be reduced significantly at higher operating temperatures. Thus, many retrofit LED light fixtures do not provide the anticipated benefits or longer life due to inadequate thermal ventilation and configuration. Therefore, there exists a need for a system for mounting LED board rails to a fluorescent light fixture that is easy to install.

### SUMMARY

In view of the foregoing background, it is therefore an object of the present invention to provide an improved LED board rail mounting system for retrofitting fluorescent light fixtures.

This and other objects, features, and advantages in accordance with the present invention are provided by a light emitting diode (LED) board rail for retrofitting a fluorescent light fixture. The LED board rail includes an LED board having a plurality of LEDs, an elongated optical cover housing the LED board along its length, where the elongated optical cover has a first end and an opposing second end. The LED board rail also includes a first spring clip having a first finger and an opposing second finger. The first spring clip coupled to the first end of the elongated optical cover. Similarly, a second spring clip having a first finger and an opposing second finger is coupled to the second end of the elongated optical cover. The first and second spring clips are configured to engage respective first and second slots formed into a ballast cover of the existing fluorescent light fixture for first and second lamp holders.

A method aspect is directed to a method of retrofitting an LED board rail to a fluorescent light fixture, where the LED board rail includes an LED board having a plurality of LEDs, an elongated optical cover housing the LED board along its length, a first spring clip coupled to a first end of the elongated optical cover, a second spring clip coupled to a second end of the elongated optical cover, and the first and second spring clips configured to engage respective first and second slots formed into the ballast cover of the fluorescent light fixture for first and second lamp holders. The method includes removing an elongated lens from the fluorescent light fixture, removing fluorescent lamps and lamp holders from the fluorescent light fixture, and removing a ballast cover of the fluorescent light fixture. The method also includes installing an LED driver into the fluorescent light fixture, and replacing the ballast cover over the LED driver. In addition, the method includes inserting the first and second spring clips of the LED board rail into the respective first and second slots formed into the ballast cover from where the first and second lamp holders were removed, and replacing the elongated lens over the LED board rail.

### BRIEF DESCRIPTION OF THE DRAWINGS

FIG. 1 is a perspective view of a LED board rail in accordance with the invention;

FIG. 2 is a perspective view of an end cap of the LED board rail of FIG. 1;

FIG. 3 is a top perspective end view of the LED board rail with the end cap removed;

FIG. 4 is a bottom perspective view of the end cap;

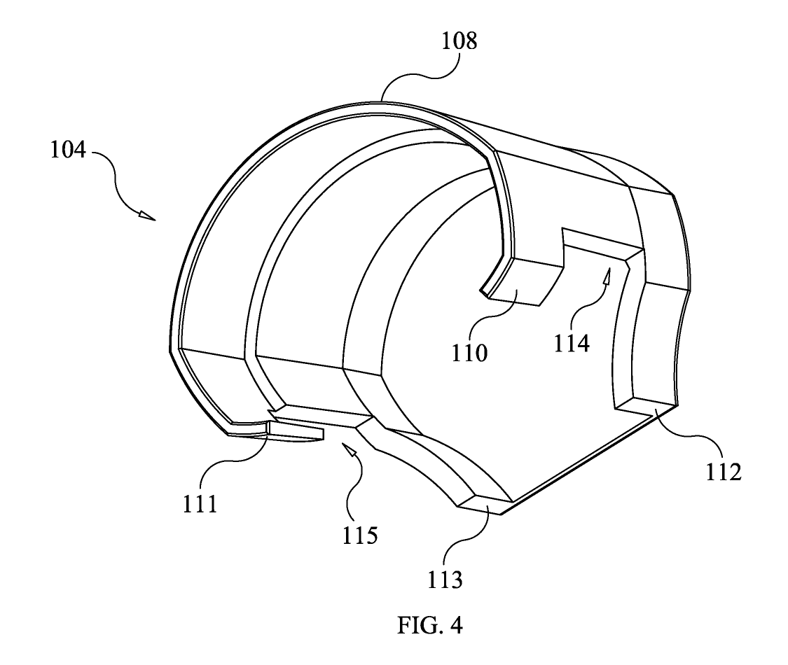

FIG. 5 is a perspective view of a spring clip of the invention;

FIG. 6 is an exploded perspective view of fluorescent lamps and lamp holders removed from a light fixture;

FIG. 7 is a perspective view of a ballast cover removed from the light fixture;

FIG. 8 is a perspective view of an LED driver installed into the light fixture in accordance with the invention;

FIG. 9 is a perspective view of the ballast cover installed over the LED driver;

FIG. 10 is a perspective view of the LED board rails installed into the light fixture; and

FIG. 11 is a perspective view of a lens installed on the light fixture over the LED board rails.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The snap-in LED board rail system is configured to be snapped into existing linear fluorescent light fixtures using the lamp holder slots cut out in the lamp bracket. The size and location of the slots are dictated by standardized sizes of fluorescent lamps. The snap-in LED board rail system simulates the combination of the fluorescent lamp and their respective lamp holders, which snaps in similarly to the fluorescent parts. Accordingly, the snap-in LED board rail system reduces the need for custom bracketry or mechanical modification to the existing fluorescent fixture during a retrofitting process.

An advantageous aspect of the snap-in LED board rail system is that leaving the electrical enclosure as-is will most likely lead to easier acceptance by safety and performance regulatory agencies, quicker installation and lower cost of upgrading the light fixture to new technology when compared to other existing retrofitting kits that require modification to the existing fixture. The snap-in LED board rail system is superior to common LED tubes because they do not require high voltage AC to be passed into the lamp holders. Thus, there is a reduced risk of electrical shock during relamping or potential of accidental confusion between fluorescent and LED replacement lamps.

Fluorescent light tubes such as the T12, T8 and T5 as they are commonly known, are used widely across the industry. Accordingly, there are many fixture styles which could be upgraded with the snap-in LED board rail system described herein. In addition, many different embodiments of the snap-in LED board rail system are possible to accommodate the different lamp holder styles.

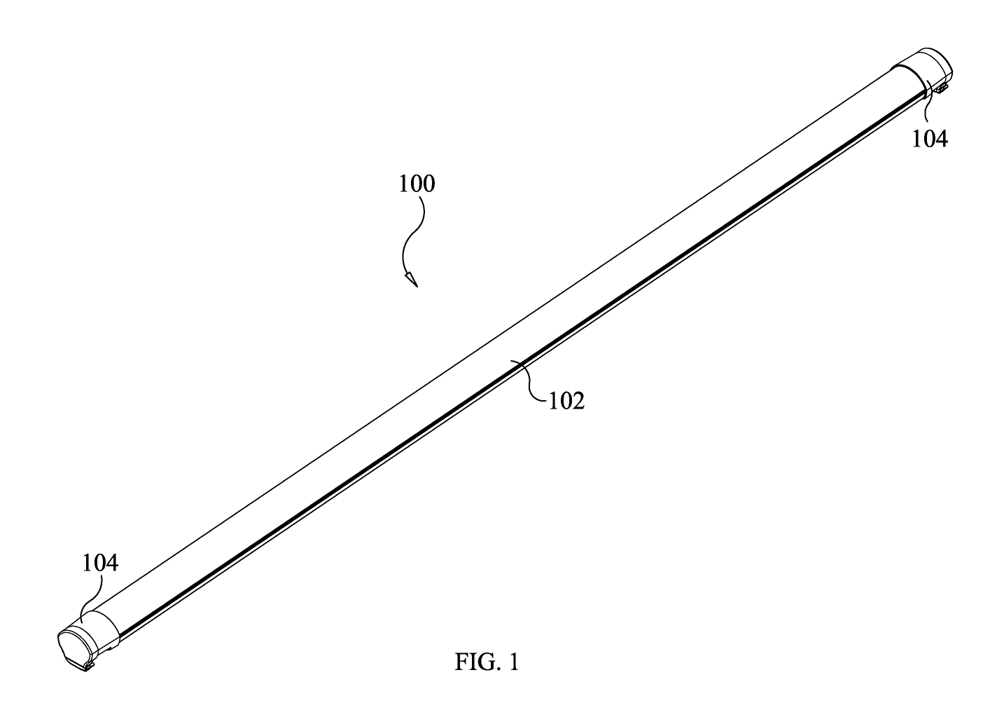

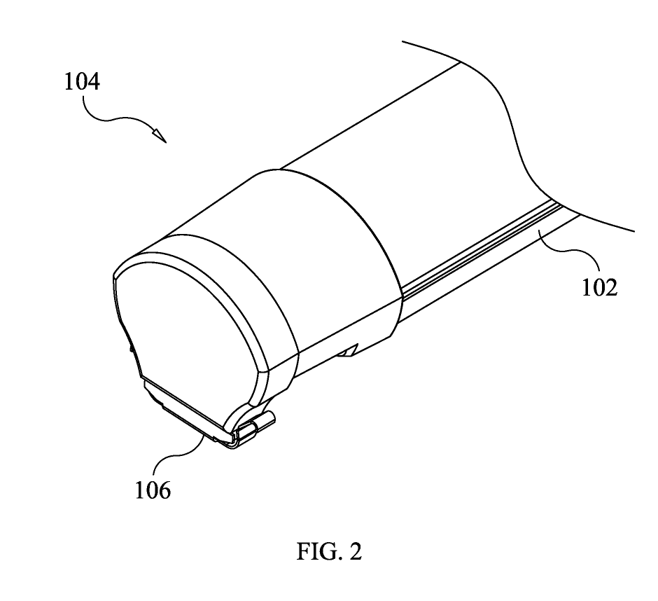

Referring initially to FIG. 1, an LED board rail 100 includes an elongated optical cover 102 with an endcap 104 at a first end and an opposing second end of the LED board rail 100. The endcap 104 is configured to slide directly over a surface of the elongated optical cover 102 as shown in FIG. 2. The endcap 104 also is used to secure a spring clip 106 to the end of the LED board rail 100.

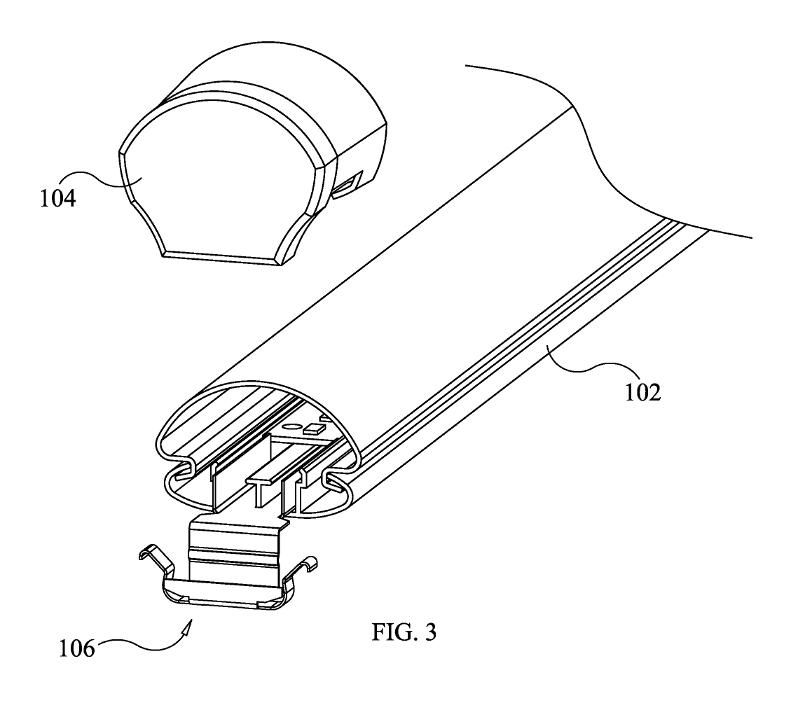

With the endcap 104 removed as shown in FIG. 3, the inside of the LED board rail 100 is visible. In particular, the spring clip 106 is illustrated having a first portion inserted into the end of the elongated optical cover 102 and a second portion extending downward and out from the end of the elongated optical cover 102. The LED board 105 is also visible from the end of the elongated optical cover 102.

The endcap 104 includes an upper curved surface 108 that is configured to match the curvature of the elongated optical cover 102. The endcap 104 also includes a rear surface that serves to fit over the end of the elongated optical cover 102 when the endcap 104 is secured thereto. Adjacent to the rear surface is a first edge 112 that extends away from the rear surface, and one side and a second edge 113 that also extends away from the rear surface. The first and second edges 112, 113 are orientated to be adjacent to the fingers of the spring clip discussed in more detail below. A first prong 110 extends downward from the upper surface of the endcap 104 and a second prong 111 also extends down away from the upper surface on an opposing side of the endcap 104. The first and second prongs 110, 111 are spaced apart from the first and second 112, 113 edges by first and second cut-outs 114, 115, respectively. The first and second prongs 110, 111 are configured to grip a lower surface of the elongated optical cover 102 and be secured using a friction fit or other suitable fastener to the elongated optical cover 102.

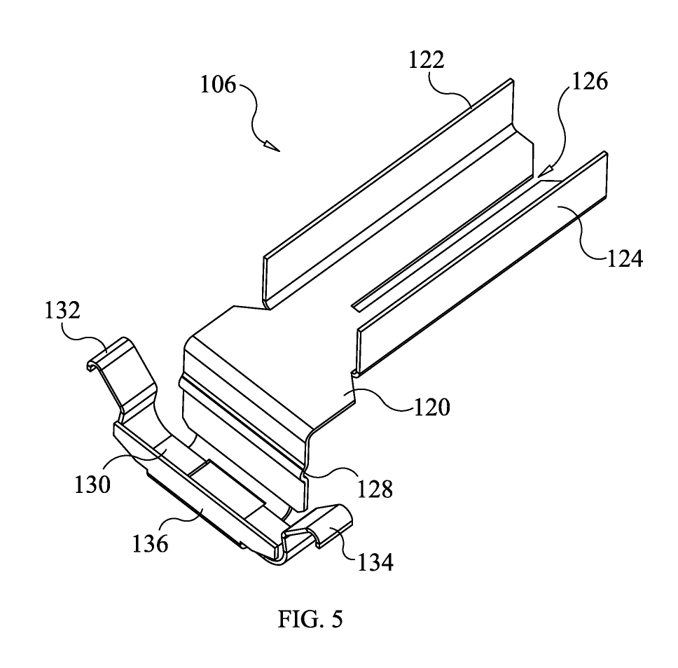

Referring now to FIG. 5, the spring clip 106 is shown in more detail. A similar spring clip 106 is coupled to both the first and second ends of the LED board rail 100 and are used to secure the LED board rail 100 to the light fixture. The spring clip 106 includes a channel 126 on a first portion that is formed by opposing sidewalls 122, 124. The channel 126 is configured to slide into the open end of the elongated optical cover 102. An upper plate 120 joins an end of the channel 126 to a step 128 that joins a lower plate 130 of a second portion.

A first finger 132 extends upwards from the lower plate 130 and a second finger 134 extends upwards from an opposing the lower plate 130 on an opposing edge from the first finger 132. The spring clip 106 is configured to engage a slot formed into a ballast cover of the existing fluorescent light fixture for a lamp holder. When the lamp holder is removed leaving a void, the spring clip 106 snaps into that void and secured the LED board rail to the light fixture without further modification. An endwall 136 extends upwards from the lower plate 130 and is configured to rest directly adjacent to the endcap 104 when assembled.

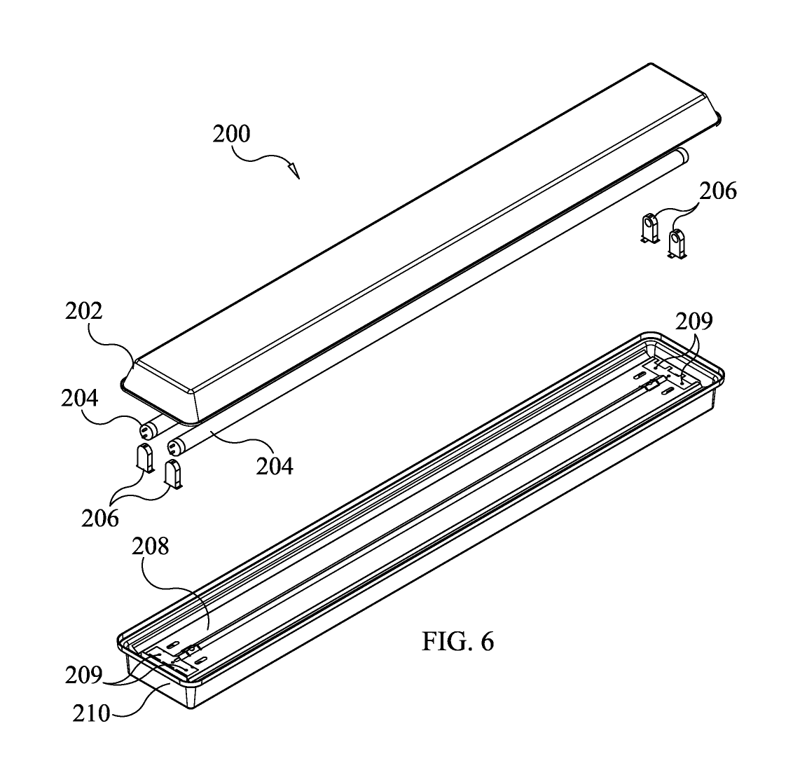

Referring now to FIGS. 6-11, a method of retrofitting LED board rails to a fluorescent light fixture is disclosed. As illustrated in FIG. 6, an exploded view of a typical light fixture 200 is shown. The light fixture 200 includes a lens 202, a pair of fluorescent lamps 204, a pair of lamp holders 206 (also referred to as sockets), and a ballast cover 208. The lamp holders 206 have been removed from the ballast cover 208 leaving slots 209. The light fixture also includes a bottom casing 210. Removing the lens 202, fluorescent lamps 204, and lamp holders 206 initiates the method of retrofitting the fluorescent light fixture 200 with LED board rails 100 described above.

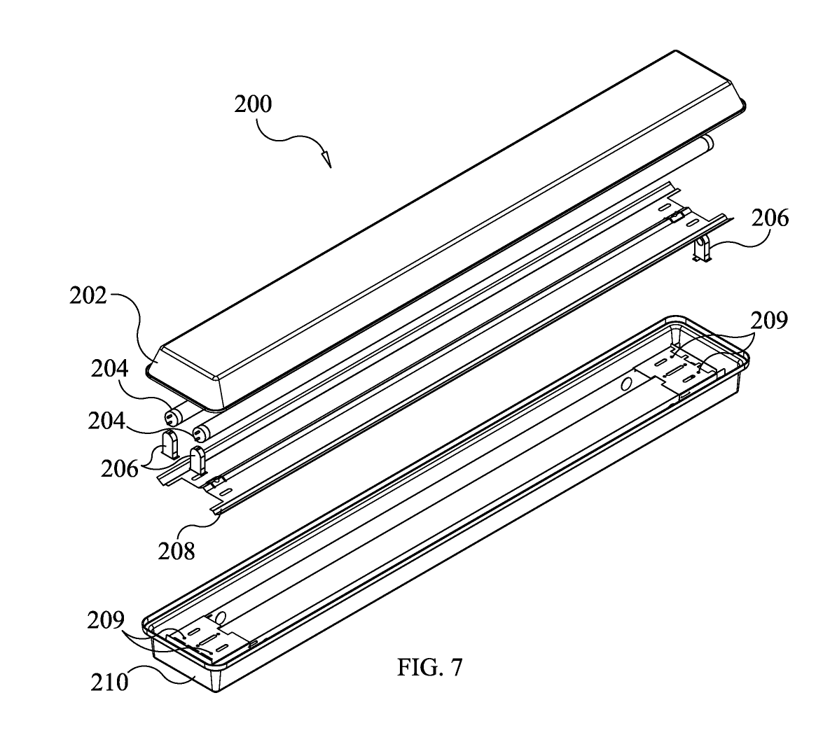

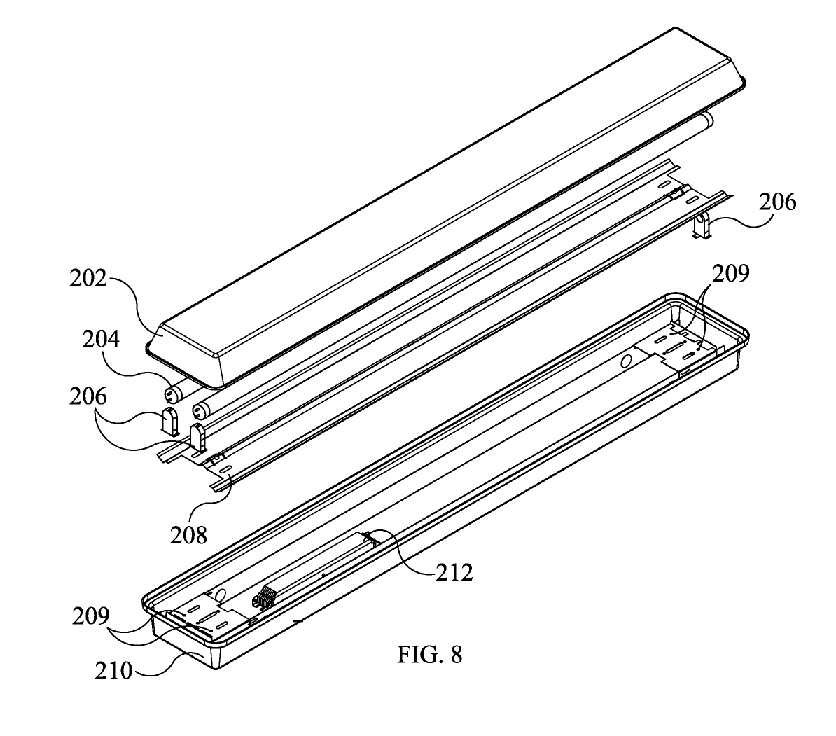

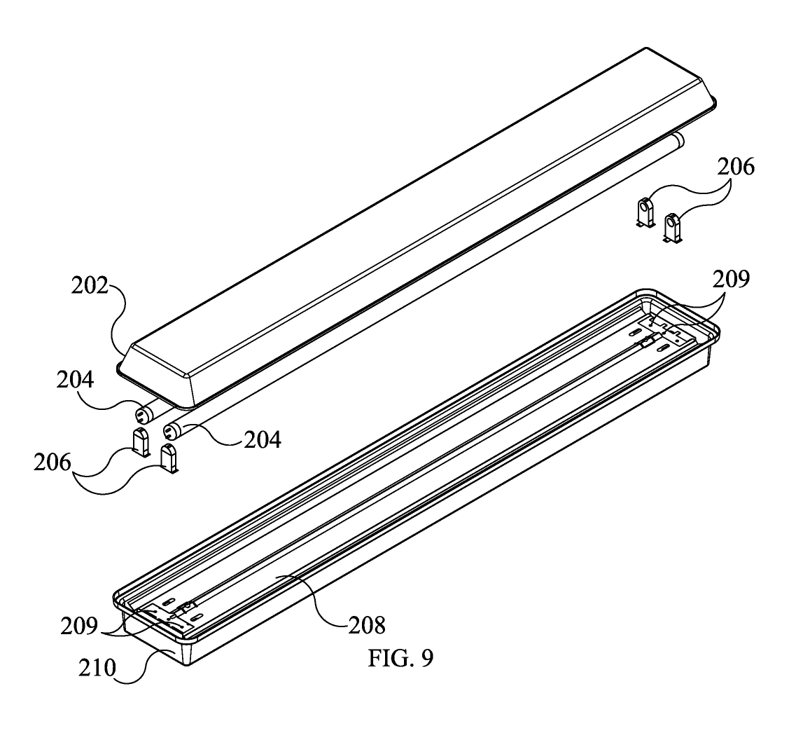

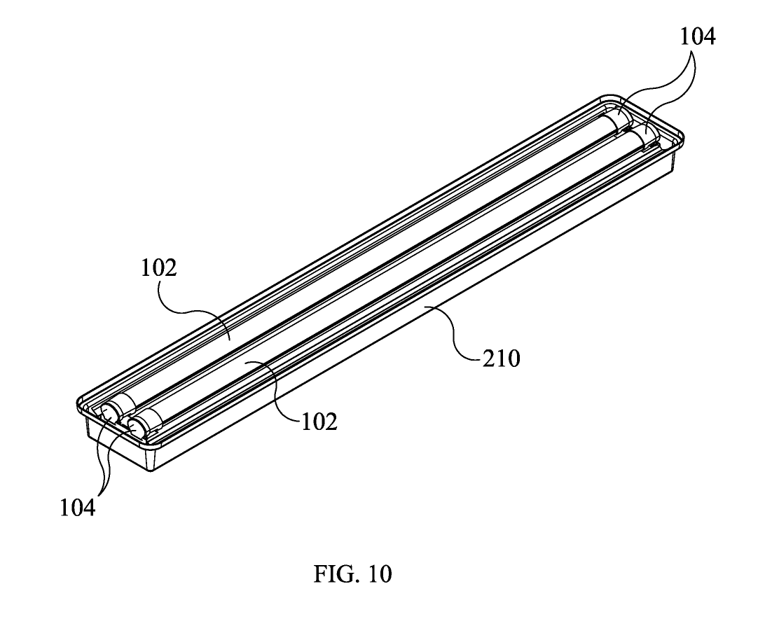

Moving to FIG. 7, the ballast cover 208 has been removed in order to access circuitry within the bottom casing 210. An LED driver 212 is installed, as shown in FIG. 8, into the bottom casing 210 and the electrical connections are made. The ballast cover 108, in FIG. 9, is replaced into the light fixture 200. The LED board rails 100 are snapped into the slots 209 using the spring clips 106 on either end of the LED board rails 100, in FIG. 10. The LED board rails 100 are orientated in the same location that fluorescent bulbs would be located.

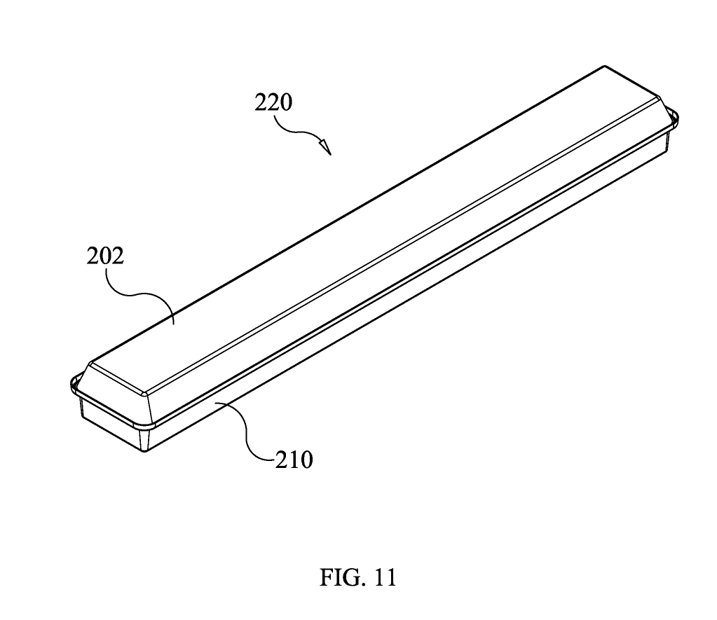

As shown in FIG. 11, the lens 202 has been replaced over the bottom casing 210 and the fluorescent light fixture 100 has been retroffited with LED board rails 100 to an LED light fixture 220.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A light emitting diode (LED) board rail for retrofitting a fluorescent light fixture, the LED board rail comprising:
an LED board having a plurality of LEDs;
an elongated optical cover housing the LED board along its length, the elongated optical cover having a first end and an opposing second end;
a first spring clip having a first finger and an opposing second finger, the first spring clip coupled to the first end of the elongated optical cover;
a second spring clip having a first finger and an opposing second finger, the second spring clip coupled to the second end of the elongated optical cover; and
the first and second spring clips configured to engage respective first and second slots formed into a ballast cover of the existing fluorescent light fixture for first and second lamp holders.

2. The LED board rail of claim 1, wherein the first spring clip comprises a first channel extending away from the first finger and opposing second finger of the first spring clip, and the second spring clip comprises a second channel extending away from the first finger and opposing second finger of the second spring clip.

3. The LED board rail of claim 2, wherein the first channel is configured to slide into the first end of the elongated optical cover, and the second channel is configured to slide into the second end of the elongated optical cover.

4. The LED board rail of claim 1, further comprising a first endcap securing the first spring clip to the first end of the elongated optical cover, and a second endcap securing the second spring clip to the second end of the elongated optical cover.

5. The LED board rail of claim 4, wherein the first and second endcaps each comprise an upper surface configured to slide directly over a surface of the elongated optical cover.

6. The LED board rail of claim 1, wherein the first and second fingers of each of the first and second spring clips extends below a lower surface of the elongated optical cover.

7. The LED board rail of claim 1, wherein the first clip and the second clip each comprise a bottom surface spacing apart the respective first and second opposing fingers.

8. The LED board rail of claim 7, wherein the first and opposing second fingers are configured to be squeezed together in order to insert the respective first and second clips into the respective first and second slots.

9. The LED board rail of claim 7, wherein the first finger and opposing second finger of each of the first and second spring clips extends upwards from the bottom surface.

10. A system for retrofitting a fluorescent light fixture with light emitting diode (LED) board rails, the system comprising:
an LED driver configured to be secured to a bottom casing of the fluorescent light fixture;
an LED board rail configured to be coupled to the LED driver and secured to a top surface of a ballast cover and be covered by an elongated lens secured over the LED board rail and to the bottom casing;
the LED board rail comprising
an LED board having a plurality of LEDs,
an elongated optical cover housing the LED board along its length, the elongated optical cover having a first end and an opposing second end,
a first spring clip coupled to the first end of the elongated optical cover,
a second spring clip coupled to the second end of the elongated optical cover, and
the first and second spring clips configured to engage respective first and second slots formed into the ballast cover of the fluorescent light fixture for first and second lamp holders.

11. The system of claim 10, wherein the first spring clip comprises a first channel extending away from a first finger and opposing second finger of the first spring clip, and the second spring clip comprises a second channel extending away from a first finger and opposing second finger of the second spring clip.

12. The system of claim 11, wherein the first channel is configured to slide into the first end of the elongated optical cover, and the second channel is configured to slide into the second end of the elongated optical cover.

13. The system of claim 10, further comprising a first endcap securing the first spring clip to the first end of the elongated optical cover, and a second endcap securing the second spring clip to the second end of the elongated optical cover.

14. The system of claim 13, wherein the first and second endcaps each comprise an upper surface configured to slide directly over a surface of the elongated optical cover.

15. The system of claim 11, wherein the first and second fingers of each of the first and second spring clips extends below a lower surface of the elongated optical cover.

16. The system of claim 11, wherein the first clip and the second clip each comprise a bottom surface spacing apart the respective first and second opposing fingers.

17. The system of claim 16, wherein the first and opposing second fingers are configured to be squeezed together in order to insert the respective first and second clips into the respective first and second slots.

18. The system of claim 16, wherein the first finger and opposing second finger of each of the first and second spring clips extends upwards from the bottom surface.

19. A method of retrofitting a light emitting diode (“LED”) board rail to a fluorescent light fixture, the LED board rail comprising an LED board having a plurality of LEDs, an elongated optical cover housing the LED board along its length, the elongated optical cover having a first end and an opposing second end, a first spring clip coupled to the first end of the elongated optical cover, a second spring clip coupled to the second end of the elongated optical cover, and the first and second spring clips configured to engage respective first and second slots formed into the ballast cover of the fluorescent light fixture for first and second lamp holders, the method comprising:
removing an elongated lens from the fluorescent light fixture;
removing fluorescent lamps and lamp holders from the fluorescent light fixture;
removing a ballast cover of the fluorescent light fixture;
installing an LED driver into the fluorescent light fixture;
replacing the ballast cover over the LED driver;
inserting the first and second spring clips of the LED board rail into the respective first and second slots formed into the ballast cover from where the first and second lamp holders were removed; and
replacing the elongated lens over the LED board rail.

20. The method of claim 19, wherein the first spring clip and the second spring clip each comprise comprises a first finger and an opposing second finger.
